(19) United States
(12) Patent Application Publication
(10) Pub. No.: US 2005/0117024 A1
(43) Pub. Date: Jun. 2, 2005

(54) Gradient displaying method of mobile terminal

(75) Inventor: Se-Woong Lee, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/893,255

(22) Filed: Jul. 19, 2004

(30) Foreign Application Priority Data
Nov. 29, 2003 (KR) 86019/2003

(51) Int. Cl. H04N 5/228; H04N 5/222; G03B 17/18

(52) U.S. Cl. 348/208.15; 348/333.03; 396/291

(57) ABSTRACT

A gradient displaying method and a mobile terminal capable of displaying a gradient of a screen during image photographing using a camera of the mobile terminal. A gradient sensor or a horizontal/vertical angle extraction sensor such as a gravitation sensor is mounted to the mobile terminal, and gradient data against the earth's surface converted to a numerical value by an interface with a main processing device or a memory, thereby directly displaying a reference angle or straight line or angle data on the photographing screen, for example, by software. Accordingly, a user can photograph an image with a precise angle.

### BACKGROUND OF THE INVENTION

1. Field of the Invention

The present invention relates to a mobile terminal, and more particularly, to a gradient display method and a mobile terminal configured to display a gradient of a screen for photographing an image using a camera function of the mobile terminal.

2. Description of the Related Art

Presently, a camera function, a moving image photographing function, and a replaying function of a mobile terminal are becoming more popular. Accordingly, as digital camera technology develops, the camera function technology of the mobile terminal also develops, and a display unit for display of an image to be photographed by a camera using advanced techniques develops as well. Accordingly, mobile terminals having the camera feature are rapidly becoming widely used.

In an image photographing device such as a camera or a camcorder, a reference focus point may be displayed when image photographing, thus enabling a user to readily control an angle at which the image is viewed and/or photographed, whereas, mobile terminals having the camera feature only display a photographing image on a screen, and an angle of inclination is not displayed for the user.

Therefore, when photographing an image using the mobile terminal, a correct horizontal photographing is difficult, if not impossible, to obtain, without use of an accessory such as a camera stand or other stabilizing/leveling device. “Leveling” of a hand-held mobile terminal is increasingly difficult the lighter in weight the mobile terminal.

Even if techniques for controlling a gradient of the screen were to be available by software, the techniques would be limited to large, imprecise angles, such as 45°, 90°, or 180° of an upper and lower inversion, and thereby ineffective for compensating a more precise, minute gradient.

### SUMMARY OF THE INVENTION

An object of the invention is to solve at least the above problems and/or disadvantages and to provide at least the advantages described hereinafter.

Another object of the present invention is to display a gradient of a screen when photographing an image using a camera function of the mobile terminal.

To achieve these and other advantages and in accordance with the purpose of the present invention, as embodied and broadly described herein, there is provided a gradient displaying method of a mobile terminal including determining whether the mobile terminal is in a photographing mode state, and detecting gradient data of the mobile terminal if the mobile terminal is in a photographing mode state. The method also includes processing the detected gradient data into a numerical value and displaying the numerical value on a screen.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements, wherein:

FIGS. 1A and 1B are an overview illustrating a display unit of a mobile terminal to which one example of a gradient displaying method of a mobile terminal according to the present invention is applied;

FIG. 2 is another overview illustrating a display unit of a mobile terminal to which another example of a gradient displaying method of a mobile terminal according to the present invention is applied;

FIG. 3 is yet another overview illustrating a display unit of a mobile terminal to which still another example of a gradient displaying method of a mobile terminal according to the present invention is applied; and

FIG. 4 is a flow chart illustrating a process for displaying a gradient of a mobile terminal according to the present invention.

### DETAILED DESCRIPTION

Reference will now be made in detail to a number of examples of the present invention, some of which are illustrated in the accompanying drawings.

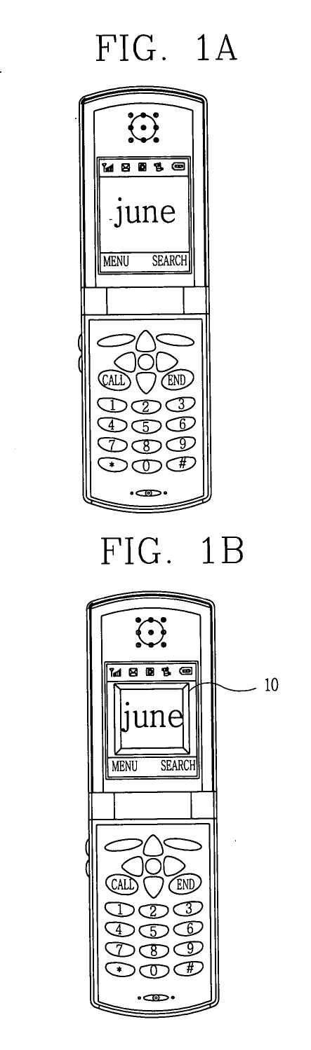

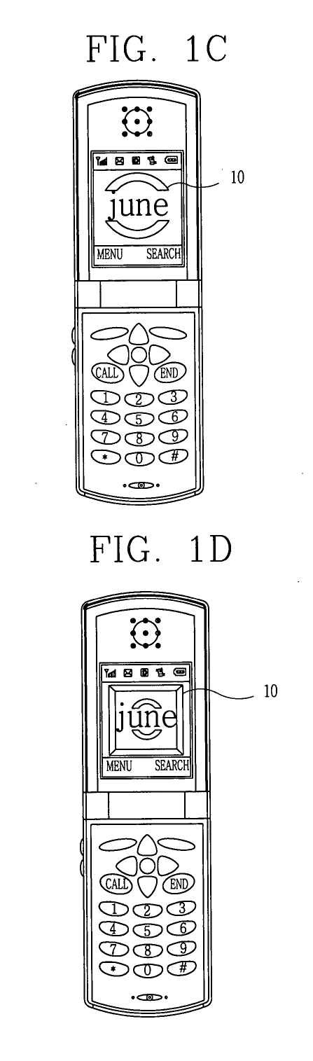

FIGS. 1B-1D illustrate a mobile terminal including a reference frame 10 having a quadrangular shape and/or an arc shape, for example, displayed on a display unit of the mobile terminal when using a camera function, thereby indicating to the user gradient information of the mobile terminal, to permit the user to photograph an image at a desired angle of position.

Further, FIG. 1A illustrates a display unit of a mobile terminal in which a frame is not displayed, and FIGS. 1B to 1D are views illustrating display units of a mobile terminal having the reference frames 10 of various exemplary types according to the present invention.

The reference frame 10 may include various shapes in addition to the illustrated quadrangular shape (FIGS. 1B and 1D) and the arc shape (FIGS. 1C and 1D), such as a triangle, a hexagon, and the like, as well as multiple shapes. The shape of the reference frame 10 can be selected, preset, altered and/or added by the manufacturer, service provider, and/or user, etc.

The reference frame 10 need not be visible or displayed on an actual photographed image, but can be superimposed, for example, for display on the display unit for the convenience of image photographing by the user of the camera feature of the mobile terminal.

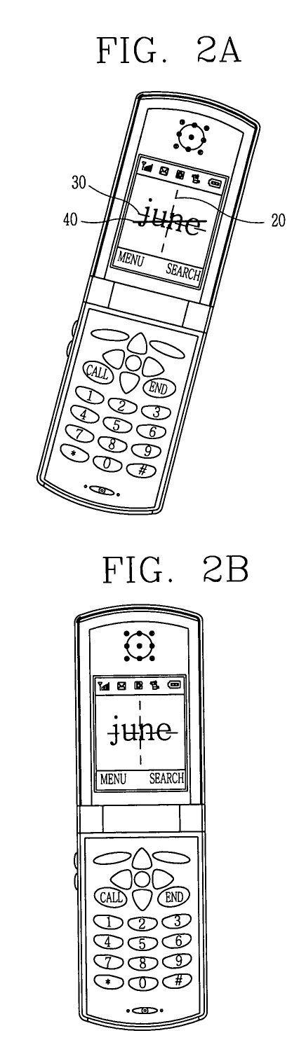

FIGS. 2A-2C illustrate a display unit of a mobile terminal to which another example of a gradient displaying method of a mobile terminal according to the present invention can be applied.

As shown, in the gradient displaying method of a mobile terminal according to the present invention, a gradient sensor can be mounted or formed inside and/or outside the mobile terminal, to thereby allow display of a gradient degree or amount of inclination of the mobile terminal on the display unit.

A horizontal value measured by the gradient sensor can be displayed or projected on the display unit of the mobile terminal, and a reference coordinate system can also be displayed or visible, thereby enabling the user to precisely determine the gradient degree or horizontal offset of the mobile terminal.

Herein, the horizontal value measured by the gradient sensor can be displayed or present as a horizontal demarcation or horizontal line 40 as shown in FIGS. 2A and 2C to thereby be compared, for example, qualitatively with the reference coordinate system, and/or can be numerically or quantitatively displayed at one side of the display unit. The horizontal line and the numeric data can be displayed or provided together.

The reference coordinate system may be outputted to the display unit of the mobile terminal, and may include a reference vertical line 20 and/or a reference horizon indicator or horizontal line 30 that can be inclined or angled according to a gradient or position of the mobile terminal. The horizontal line 40 indicating a gradient or inclination value measured by the gradient sensor can be set to be horizontal or level with the earth's surface, independent of the actual gradient or orientation of the mobile terminal.

Therefore, by substantially aligning the reference horizontal line 30 of the reference coordinate system and the gradient horizontal line 40 with each other when photographing, a horizontal screen can be viewed and/or photographed to within a desired degree of precision. Also, if photographing is performed such that the reference vertical line 20 of the reference coordinate system and the gradient horizontal line 40 are substantially perpendicular to each other, a vertical screen can be obtained and/or photographed to within a desired degree of precision. In addition, it is possible to photograph an image at a desired gradient using gradient numeric data displayed by the display unit according to an embodiment of the present invention.

FIG. 2A is a view illustrating a reference coordinate system and the gradient horizontal line, for example, where the mobile terminal is inclined or tilted by approximately 15° to the right. FIG. 2B is a view illustrating the reference coordinate system and the gradient horizontal line, for example, where the mobile terminal is oriented to be substantially horizontal or even with the earth's surface. FIG. 2C is a view illustrating the reference coordinate system and the gradient horizontal line, for example, where the mobile terminal is inclined or rotated by approximately 15° to the left.

The reference coordinate system and the gradient horizontal line need not be displayed or present on an actual photographed image, but can be superficially displayed on the display unit for the convenience of image photographing by the user of the mobile terminal as a camera.

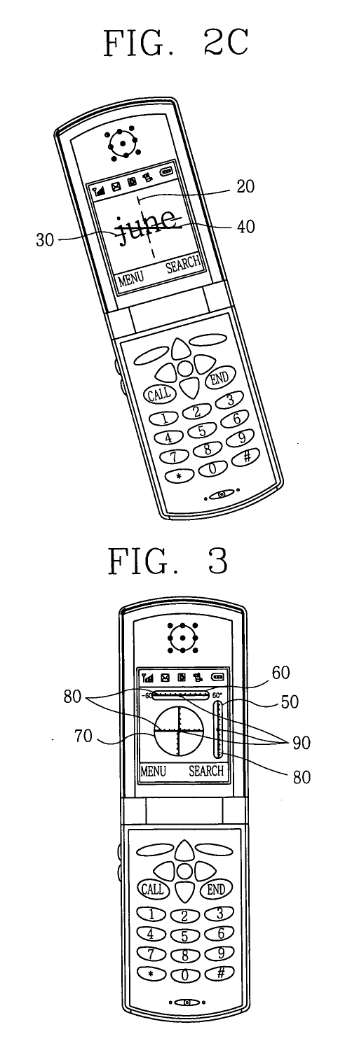

Next, FIG. 3 illustrates a display unit of a mobile terminal to which still another example of the gradient displaying method of a mobile terminal according to the present invention is applied.

As shown, in the gradient displaying method of a mobile terminal according to the present invention, a horizontal gradient angle and a vertical gradient angle measured by the gradient sensor provided or formed inside and/or outside the mobile terminal can be, individually or combinationally, quantitatively displayed on the display unit of the mobile terminal, thereby configured for use as horizontal and/or vertical angle gauges.

Herein, selected gradients are graphically displayed on a screen of the display unit of the mobile terminal accordingly as vertical and/or horizontal values measured by the gradient sensor are processed or converted into a vertical gauge 50, a horizontal gauge 60, and/or a plane gauge 70, so that the user can readily determine vertical and/or horizontal angles of inclination of the mobile terminal. For more minuteness or precision, gradients or angles can be displayed quantitatively as texts and/or numbers. The horizontal gauge 60 can denote a horizontal gradient of the mobile terminal, the vertical gauge 50 can denote a vertical gradient of the mobile terminal, and/or the plane gauge 70 can denote a direction in which the mobile terminal is inclined. The gauges can be figures other than what is illustrated.

The gauges 50, 60, 70 may or may not be ruled. That is, one or more of the gauge lines 80 in at least one of the gauges 50, 60, 70 can be divided and/or sub-divided by markings or indications to any desired degree of precision. As shown in FIG. 3, for example, the gauge lines 80 can be marked off in about 10°, 5°, or 1° intervals or units, as well any combinations thereof. Other units of measurement of the angle of inclination can be used. A pointer or indicator 90 can move along the gauge line 80 to correspond with a gradient of the mobile terminal.

To use the vertical gauge, the horizontal gauge, and/or the plane gauge as a measurer, an additional ‘measurer mode’ menu can be provided to be displayed on the view screen, for example, during menu selection. The vertical/horizontal/plane gauges need not be displayed or formed on an actual photographed image, but can be overlaid or independently displayed on the display unit for the convenience of image photographing by the user of the mobile terminal in the camera mode.

In the gradient displaying method of a mobile terminal, not only the gradient sensor, but also the horizontal/vertical angle extraction sensor including a gravitation sensor can be provided.

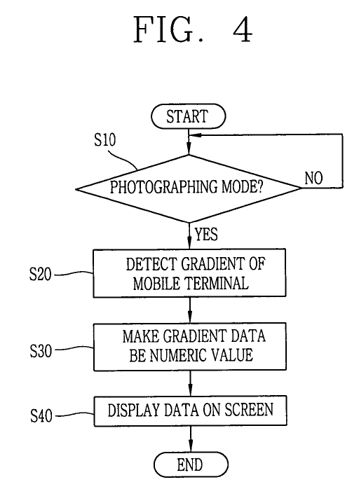

FIG. 4 is a flow chart illustrating a process for displaying a gradient of a mobile terminal according to the present invention.

Referring to FIG. 4, first it is determined whether the mobile terminal is in a photographing mode state (S10). Then a gradient degree of the mobile terminal relative to the earth's surface can be detected by the gradient sensor or the horizontal and/or vertical angle extraction sensor, such as a gravitation sensor, mounted inside and/or outside the mobile terminal if the mobile terminal is determined to be in a photographing mode state (S20).

Next, the gradient data detected by the horizontal/vertical angle extraction sensor can be converted or processed into a numerical value or numeric data, for example, by an interface with a main processing device and/or a memory (S30).

Then, the numeric data directly provided or displayed on the screen, for example, as straight line data and/or angle data, thus to facilitate the user's photographing convenience (S40).

As aforementioned, in the gradient displaying method of a mobile terminal, a gradient of the camera can be displayed on the screen a predetermined or selected time using the mobile terminal, so that a gradient against the horizontal line or the vertical line on the basis of the earth's surface can be accurately recognized or determined, and thereby the user's convenience can be increased in photographing an image using the mobile terminal.

Also, in the present invention, the measurer mode can be provided thus to directly provide or display a precise reference angle and straight line and/or angle data on the view screen, thereby being utilized to a measurement in more professional field.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

1. A gradient displaying method of a mobile terminal, the method comprising:
determining whether the mobile terminal is in a photographing mode, and detecting gradient data of the mobile terminal if the mobile terminal is in the photographing mode;
processing the detected gradient data to form a numerical value; and
displaying the numerical value on the mobile terminal.

2. The method of claim 1, wherein the gradient data is detected by a horizontal angle extraction sensor, a vertical angle extraction sensor, or dual horizontal-vertical angle extraction sensor mounted to the mobile terminal based on the surface of the earth.

3. The method of claim 2, wherein the angle extraction sensor includes at least one from a gradient sensor and a gravitation sensor.

4. The method of claim 1, wherein the gradient data is processed into the numeric value by an interface with a main processing device, a memory, or both.

5. The method of claim 1, wherein the at least one figure includes a reference coordinate system, a gradient horizontal line, or both.

6. The method of claim 1, further comprising:
providing the mobile terminal with a measurement mode menu; and
displaying the numerical data at a time of menu selection.

7. The method of claim 6, wherein displaying the numerical value includes display of at least one gauge including text and numbers including angles.

8. The method of claim 1, further comprising:
altering at least one figure displaying the numerical value by a user; or
adding at least one figure displaying the numerical value by a user.

9. The method of claim 1, wherein the numerical value displayed is not displayed in a photographed image.

10. A gradient displaying method of a mobile terminal provided with a camera comprising:
displaying a reference frame on the mobile terminal to indicate use of a camera function of the mobile terminal.

11. The method of claim 10, wherein the reference frame includes a quadrangular shape, an arc shape, a circle shape, a triangle shape, a hexagon shape, or any combination thereof.

12. The method of claim 10, wherein a shape of the reference frame is altered, added or both by a user's setting.

13. The method of claim 10, wherein the reference frame is not visible in an actual photographed image acquired by the mobile terminal.

14. The gradient displaying method of claim 7, wherein the gauge includes gauge lines having division intervals of 10°, 5°, 1°, or a combination thereof.

15. A mobile terminal comprising:
an imaging device;
a sensor to acquire orientation information of the imaging device; and
a display unit to display the orientation information.

16. The mobile terminal of claim 15, wherein the orientation information is textually displayed.

17. The mobile terminal of claim 15, wherein the orientation information is graphically displayed.

18. The mobile terminal of claim 15, wherein the orientation information comprises qualitative data.

19. The mobile terminal of claim 15, wherein the orientation information comprises quantitative data.

20. The mobile terminal of claim 19, wherein the quantitative data is displayed to a precision of about 10° or less.
